(19) United States
(12) Patent Application Publication
(10) Pub. No.: US 2013/0239598 A1
(43) Pub. Date: Sep. 19, 2013

(54) AIRCRAFT ENVIRONMENTAL CONTROL SYSTEM WITH CONDITIONED HEAT SINK

(71) Applicant: AIRBUS OPERATIONS GMBH, Hamburg (DE)

(72) Inventor: Jan Barkowsky, Schwerin (DE)

(73) Assignee: AIRBUS OPERATIONS GMBH, Hamburg (DE)

(21) Appl. No.: 13/858,338

(22) Filed: Apr. 8, 2013

Related U.S. Application Data
(63) Continuation of application No. PCT/EP2011/067494, filed on Oct. 6, 2011.
(60) Provisional application No. 61/391,252, filed on Oct. 8, 2010.

(30) Foreign Application Priority Data
Oct. 8, 2010 (DE) 10 2010 047 970.5

(51) Int. Cl. B64D 13/00

(52) U.S. Cl. CPC B64D 13/00
USPC 62/89; 62/239; 62/129

(57) ABSTRACT

An air conditioning system for an aircraft includes at least one air conditioning pack which for the purpose of heat dissipation can be connected to at least one cooling air inlet of the aircraft and is designed to cool air and to introduce it at a cabin pressure into a passenger cabin of the aircraft. A separately operable cooling device is designed to cool the ambient air flowing into the cooling air inlet.

### CROSS-REFERENCE TO RELATED APPLICATIONS

The present application is a continuation of International Patent Application No. PCT/EP2011/067494, filed Oct. 6, 2011, which claims priority from German Patent Application No. 10 2010 047 970.5 filed Oct. 8, 2010 and United States Provisional Patent Application No. 61/391,252 filed Oct. 8, 2010, all of which are incorporated herein by reference.

### TECHNICAL FIELD

The invention relates to an air conditioning system for aircraft with an air conditioning pack, and to a method for cooling incoming cabin air for aircraft.

### BACKGROUND TO THE INVENTION

In the state of the art, air conditioning systems for aircraft are frequently used that generate cooling performance by means of air conditioning packs which carry out an air-based cooling cycle (so-called “air cycle machines”) or by means of cold vapor processes. The cooling performance is used for cooling incoming cabin air which, depending on the design type of the air conditioning system, either entirely consists of outside air or of a mixture of outside air and cabin air. Irrespective of the cooling principle used, all air conditioning systems use cooling air as a primary heat sink which is implemented with air from the environment of the aircraft. Said air is either fed directly to the air conditioning system or effects heat dissipation indirectly by way of an intermediate cooling cycle, often with the use of primary and secondary heat exchangers which from the point of view of their size in each case are optimized either for flight operation or for ground operation. With the aircraft on the ground, providing cooling air, furthermore, most of the time takes place by means of a cooling fan, while in flight the aerodynamic ram air pressure is sufficient to convey ambient air.

Systems and methods are known which in order to further reduce the cooling air temperature inject water into the cooling air duct upstream of the heat exchanger, wherein the injected water by means of a vaporization process in unsaturated cooling air can reduce the temperature of said cooling air. To this effect the water to be injected can be obtained from condensate produced by a cooling device or an intermediate cooling device of the air conditioning system itself.

Typically the design of the cooling performance to be produced by the air conditioning system caters for theoretical operational situations on the ground with extreme outside air temperature. This ensures that in all imaginable operational situations of the aircraft the air conditioning system can provide adequate cooling performance.

EP 1 129 940 A1 and US 6 415 621 B2 show an air conditioning system for an aircraft in which with the use of an air cycle cooling cycle unit the air fed to a passenger cabin can be cooled.

The heat sink in the form of cooling air from an aircraft environment with extreme outside air temperatures as the decisive design factor of an air conditioning system results in a situation in which within the air conditioning system very considerable cooling performance must be able to be generated because in addition to cabin-internal heat loads the heat load acting on the passenger cabin as a result of higher heat transfer from the environment of the aircraft into the passenger cabin also increases. The high heat flows to be transmitted also result in a very high cooling-air volume flow being required. In addition, the requirement relating to the output for operating compressors of an air-cycle cooling device or a cold vapor cooling device within the air conditioning system is at a very high level as a result of the high cooling-air feed temperature.

Consequently, in the design of conventionally used air conditioning systems of aircraft the majority of the components and of the energy generating systems used need to be designed for this operational situation. Since operational situations with extreme outside air temperatures on the ground typically do not apply to all operators of aircraft, but only to those that fly to particularly hot locations, while nonetheless identical air conditioning packs are used in all the aircraft manufactured, the majority of aircraft operators will never fully utilize the provided cooling performance. For this reason an air conditioning system designed according to the above boundary conditions would be over-dimensioned for many aircraft operators, which is also reflected in corresponding disadvantages relating to weight and cost.

Splitting an air conditioning system into several smaller combinable packs, and individually putting together an air conditioning system for each aircraft operator with flight routes that do not change, which packs generate a lower requirement for cooling performance, would not meet the objective because air conditioning systems of aircraft usually also meet the task of generating the pressure required in the passenger cabin. Since the requirements for this are the same with all aircraft operators, leaving out some air conditioning packs would merely result in a situation in which the function of generating pressure with corresponding failure reserves cannot be met.

### BRIEF SUMMARY OF THE INVENTION

An aspect of the invention proposes an air conditioning system for an aircraft, in which dimensioning of air conditioning packs and the resulting cooling performance to be provided for rarely-occurring operational situations on the ground does not take place if at all possible. This means that such an aircraft air conditioning system to be proposed, in terms of its deliverable performance, should as far as possible be individually adaptable to the particular aircraft operator, without this requiring air conditioning packs that are over-dimensioned for the majority of aircraft operators.

The air conditioning system according to an embodiment of the invention comprises at least one air conditioning pack which is connectable to at least one cooling air inlet of the aircraft for heat dissipation and is designed to cool air and introduce it to the passenger cabin of the aircraft while at the same time providing a desired cabin pressure. According to an embodiment of the invention the air conditioning system further comprises a cooling device that is equipped to cool the ambient air flowing into the cooling air inlet, wherein the cooling device is operable separately of the air conditioning pack.

By integrating such a separate cooling device it is possible to influence the heat sink in the form of fresh ambient air to such an extent that the air conditioning pack of the air conditioning system can be dimensioned for lower performance. With such dimensioning the air conditioning pack by itself and without influencing the heat sink can preferably cope only with the predominant majority of operating situations that occur during the flight in the case of all aircraft operators. These situations do not, however, include such operational situations where extreme temperatures on the ground occur.

For the majority of aircraft operators the principally dimensioning parameter of the air conditioning pack of the air conditioning system according to an embodiment of the invention relates to the expected highest ambient temperature on the ground, which temperature is normally significantly below the maximum ambient temperature relating to all operators, as well as the maximum heat to be dissipated (“outgoing heat load”) within the passenger cabin of the aircraft with a normal equipment level. In addition to the cooling performance, components of the air conditioning system according to an embodiment of the invention are dimensioned by the air mass flow that is fed through said components to the passenger cabin. The cooling performance to be delivered is thus limited to a value that is just sufficient to cool down the air to be conveyed to the passenger cabin at a specified outside temperature, taking into account average seating density, average equipment level of heat-generating devices, and the heat input through the aircraft fuselage from the outside. For the provision of cooling performance relating to more extreme operational situations with higher ambient temperatures, a higher seating density and a more extensive equipment level, in the passenger cabin, of electronic devices and other heat-generating devices, the use of the separate cooling device is required. Since the temperature of the ambient air clearly decreases as the flight altitude increases, the air conditioning pack will continue to be able, even without the use of the separate cooling device, to generate the cooling performance required during large segments of the flight mission, irrespective of climatic conditions.

According to an embodiment of the invention, on the side of the heat sink the temperature of the available cooling air can then be reduced to such an extent that the air conditioning pack of the air conditioning system generates the cooling performance required for operation of the air conditioning system. Reducing the cooling air temperature at the cooling air inlet primarily leads to improved heat dissipation in an intermediate cooling process being ensured with the quantity of air remaining the same, so that the temperature of the incoming cabin air can be further reduced with the use of the separate cooling device. According to an embodiment of the invention it is thus possible to achieve a significantly slimmer design of the air conditioning system so that the operating conditions that are usually experienced during flight can be managed. This primarily results in lower energy requirements for operating the air conditioning system, and in significantly lower weight.

Should an aircraft temporarily have an extraordinary requirement for cooling performance, “conditioning” of the heat sink can then take place by means of a separate cooling device on the cooling air inlet. Accordingly, the essential effect is thus in a significant temperature spread on the cooling air inlet, which temperature spread is carried out totally independently of operation of the actual air conditioning pack.

In an advantageous embodiment of the air conditioning system according to the invention this independence of the additional cooling device on the cooling air inlet is used in a particularly advantageous manner in that the cooling device is designed as a module that is accommodatable in a module bay of the aircraft, which module bay has been provided for this. The above could be particularly advantageous in aircraft that remain for extended periods of time on the ground at extremely hot locations, because in the process of cooling down the heated-up passenger cabin to a comfortable temperature (this procedure is also known as “pull down”) a corresponding cooling device module is insertable in the module bay in order to temporarily provide the highest-possible cooling performance without having to depend on external ground-based rental units of an airport operator. The energy supply of the cooling device module need not necessarily originate from an on-board voltage supply device of the aircraft; instead it can also be supplied with energy from external equipment, be it a voltage supply device or a device supplying compressed air.

In an alternative embodiment the cooling device is designed as an independent air conditioning system that is permanently integrated in the aircraft. This type of air conditioning system is particularly suitable for an aircraft that is frequently operated in regions with extreme operating conditions on the ground. For example, aircraft could be equipped in such a manner that regularly fly from an airport in central Europe or northern Europe to tropical airports or, for example to the Arab Emirates. The additional cooling device is only operated at hot destination airports; it would, however, be unnecessary in an airport in northern Europe or central Europe.

In an equally advantageous embodiment of the air conditioning system according to the invention the separate cooling device is designed to provide, during the flight of the aircraft, cooling performance used for the cooling of devices within the aircraft. This means that the separate cooling device influences the temperature of the heat sink only on the ground, while in flight it is used exclusively for other purposes. For example, the separate cooling device could be connected not only to the cooling air inlet, but for example also to an air outlet of a space in the aircraft, so that with the use of a fan, air is conveyed from the space to the separate cooling device, where the air is cooled and subsequently, by way of an air inlet of the space, is conveyed back to the space. The space could be a freight compartment, an avionics compartment, an equipment cabinet, a cooling chamber or the like. In this context it may be beneficial to design the separate cooling device with a valve arrangement comprising a two-way valve or two switching valves so that either the cooling air inlet is connected to the separate cooling device, or an air outlet is connected to one or several spaces to be cooled. The term “avionics compartment” should be considered as only one example for an arrangement of heat-generating devices that need to be cooled during flight.

In an improvement of such an air conditioning system the separate cooling device could also comprise a heat exchanger through which a liquid coolant can flow. The coolant could be used to cool devices within the aircraft, which devices comprise a cooler through which coolant can flow.

In a further advantageous embodiment of the invention the separate cooling device could merely be designed as a heat exchanger through which a coolant could flow which during operation of the aircraft on the ground is provided by an external device. In this manner the additional weight of the separate cooling device can be reduced to a minimum because actual active cooling is provided by an external device.

Furthermore, the manner in which generating cooling performance for the separate cooling device is carried out is immaterial. For this purpose all known devices, processes and methods that can provide cooling capacity, for example air cycle processes, cold vapor processes and the like are suitable.

Operation of a separately operable cooling device could be initiated by various events. A permanently installed cooling device can, for example, be started by means of a mechanical switch or a switching command from the cockpit of the aircraft if the aircraft is in a location in relation to which switching-on the cooling device is prescribed or recommended, for example in an operation manual of the aircraft. On the other hand a modular cooling device that can be inserted in the aircraft can then commence operation as soon as it is properly inserted in the associated module bay and a flap of the module bay is closed. A further alternative could consist of a cooling device, designed in the form of a heat exchanger, to be automatically started up when it is connected to a coolant line, which might mean, for example, switching on a pump for conveying the coolant.

A particularly advantageous embodiment of the air conditioning system according to the invention comprises an arithmetic unit designed to carry out an estimate of a necessary cooling performance based on operating parameters, including, for example, the number and electrical output of electrical devices; the outside temperature; the radiation absorbency of the aircraft fuselage as a result of the individual paintwork of the aircraft operator; the number of passengers involved in the boarding and waiting phase; and the like. After such an estimate is present, the arithmetic unit is in a position to detect when a cooling performance that is providable by the air conditioning pack is exceeded, and thereafter to recommend the use of an additional, separately-operable, cooling device by emitting a corresponding signal for display in the cockpit or on a control terminal installed in a cabin of the aircraft, or, at least in the case of a permanently installed and separately operable cooling device, to automatically activate the above. Conversely, when the arithmetic unit detects that the necessary cooling performance falls below the providable cooling performance, e.g. when passengers disembark, at night during cooler temperatures and the absence of solar irradiation on the fuselage, said arithmetic unit could recommend switching-off the separately operable cooling device, or could automatically implement its deactivation.

It would also be possible to operate cooling of the ambient air on the cooling air inlet permanently, irrespective of the performance limit of the air conditioning pack. In this case, while on the one hand the power consumption of the additional cooling device would apply, on the other hand the air conditioning pack itself would be permanently relieved. Overall savings in consumption might be achieved.

Provided the cooling device is based on the principle of relief cooling, during the flight said cooling device can also be used as a source of compressed air. In this arrangement said cooling device is used in the case of failure of an air conditioning pack to at least in part take over the function of said air conditioning pack, namely to air condition the cabin air. Thus, during the flight the cooling device would primarily carry out cooling functions and air conditioning functions instead of providing secondary cooling tasks. In this manner redundancies within the air conditioning packs, for example redundancies relating to the number of compressors provided, could be reduced. For this to be possible the cooling device needs to be permanently installed in the aircraft. For pure flight operation this would be advantageous to all users; however, ground operations would then no longer be able to be carried out in a modular manner.

Another aspect of the invention includes a method for cooling incoming cabin air for a passenger cabin of an aircraft, in which method an estimate of a necessary cooling performance is carried out on the basis of operating parameters in order to, when the cooling performance providable by the air conditioning pack is exceeded, provide an additional cooling device that is operable separately, which cooling device cools the cooling air as a heat sink of the air conditioning system. As soon as the estimated necessary cooling performance falls below the cooling performance providable by the air conditioning pack without influencing the temperature of the cooling air, the separate cooling device is deactivated.

### BRIEF DESCRIPTION OF THE DRAWINGS

Further characteristics, advantages and application options of the present invention are disclosed in the following description of the exemplary embodiments and of the figures. All the described and/or illustrated characteristics per se and in any combination form the subject of the invention, even irrespective of their composition in the individual claims or their interrelationships. Furthermore, identical or similar components in the figures have the same reference characters.

FIG. 1 shows a diagrammatic block-based view of a first exemplary embodiment of the air conditioning system according to the invention.

FIG. 2 shows a diagrammatic block-based view of a further exemplary embodiment of the aircraft air-conditioning system according to the invention.

FIG. 3 shows a diagrammatic view of a method according to the invention.

FIG. 4 shows a top view of an aircraft comprising an air conditioning system according to the invention.

### DETAILED DESCRIPTION

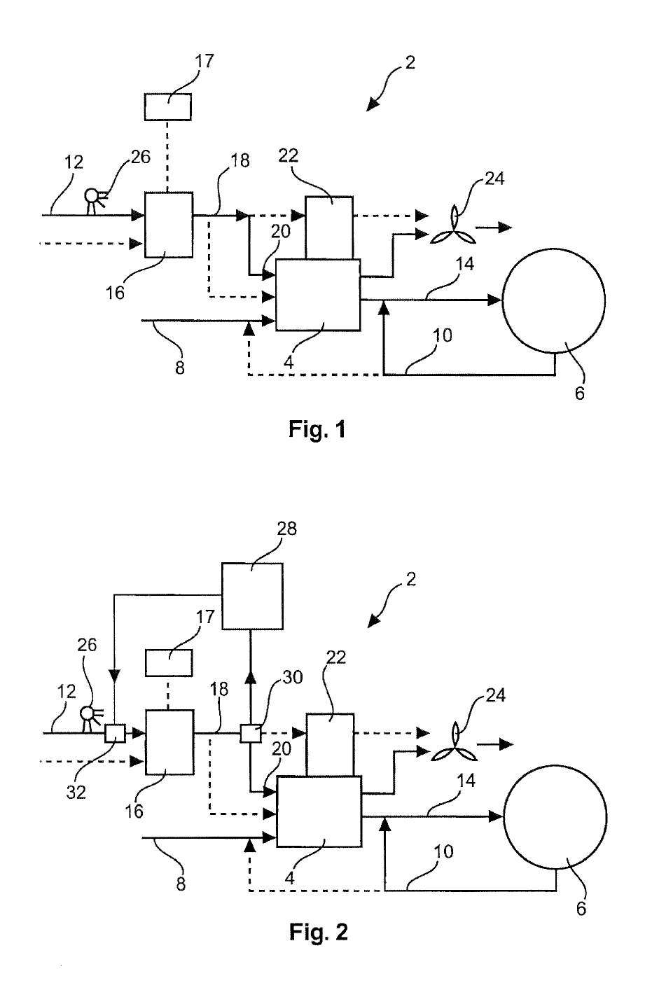

FIG. 1 shows an air conditioning system 2 according to the invention that comprises an air conditioning pack 4 for cooling air, which air conditioning pack 4 is designed to cool an incoming airflow, to pressurize it and to introduce it into a passenger cabin 6 of an aircraft. The air conditioning pack can cool not only outside air 8 but also a mixture of outside air 8 and recirculated cabin air 10.

In FIG. 1 the air conditioning pack 4 is only shown as a single block. In aircraft air conditioning systems that are commonly used at present, such air conditioning packs 4 are designed as air cycle devices in which bleed air from aircraft engines is compressed, subjected to intermediate cooling, and expanded, wherein intermediate cooling takes place by means of outside air by way of a ram air heat exchanger or the like. As an alternative to this there are also air conditioning packs 4 that are based on other thermodynamic cycle processes, wherein the type of air conditioning pack 4 is predominantly conceived according to the required cooling performance. In the illustration of the air conditioning system 2 according to an embodiment of the invention the components of the air conditioning pack 4 are thus immaterial; the following considerations are merely based on the assumption that an incoming airstream is cooled, by means of the air conditioning pack 4 with the use of an intermediate cooling device that can be subjected to ambient air, and is brought to a predetermined pressure level.

All air conditioning packs 4 may share the common feature of requiring a heat sink 12 by means of which cooling or intermediate cooling is achieved. In the shown design of the air conditioning system 2 according to an embodiment of the invention the heat sink 12 is designed as ambient air flowing to the air conditioning pack 4. For use of the aircraft on hot days on the ground the performance that can be provided by the air conditioning pack 4 is insufficient to achieve the desired state of the cabin air 14. This requires operation of a cooling device 16 subjected to ambient air 12 which then flows out of the cooling device 16 as a cooled ambient airflow 18.

The cooled ambient airflow 18 can either be conveyed directly into an input 20 of the air conditioning pack 4 or, as an alternative to the above, can, by way of an intermediate cycle 22, represent a heat sink for the air conditioning pack 4. In the latter case a cooling fan 24 might be required to serve as a heat sink for the intermediate cycle. The same applies to waste heat of the air conditioning pack 4 for ground operation, in which process the cooling fan 24 aspirates air from a fresh air inlet or the like.

For additionally cooling an ambient airflow 12 it would also be possible to provide water injection by way of a water injector nozzle 26 in which water is injected into the ambient air flow, for example into a ram air duct, where by means of vaporization in unsaturated ambient air 12 it cools said ambient air 12.

In an alternative view FIG. 2 shows a cooling device which in addition provides cooling performance for consumers 28 that can be implemented in the form of electronic devices or spaces in an aircraft when the cooling performance is not completely used by the air conditioning pack 4. To this effect a valve arrangement is imaginable which comprises valves 30 and 32 which valve arrangement causes the cooling device 16 to be subjected to air or to a coolant of the consumer 28 instead of to ambient air 12 and furthermore supplies the cooling performance partly or exclusively to the consumer.

An arithmetic unit 17 can, furthermore, in both exemplary embodiments be used, by estimating a necessary cooling performance, to switch the cooling device 16 on or off as soon as the cooling performance that can be provided by the air conditioning pack 4 is not adequate or is adequate.

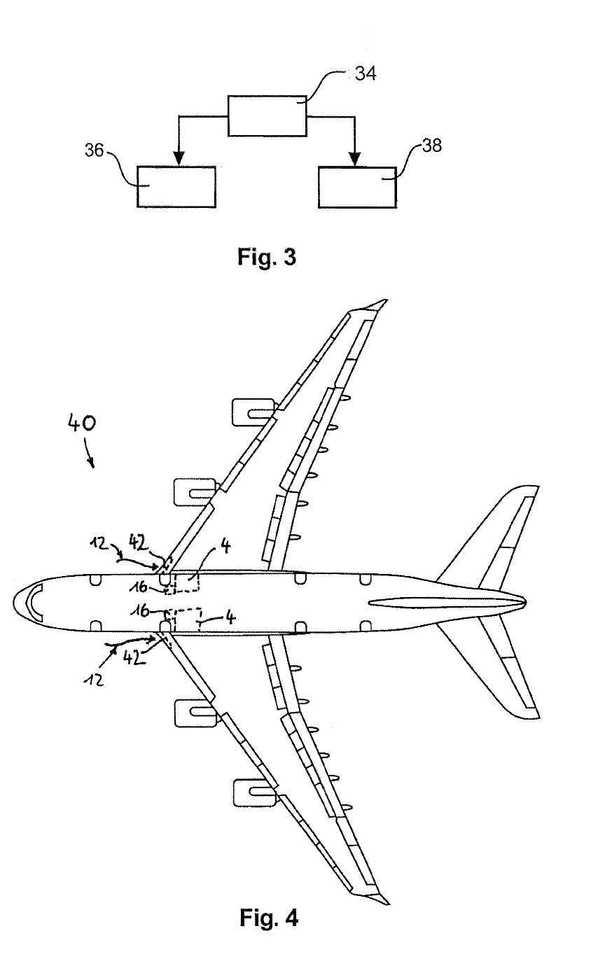

Finally, FIG. 3 shows one aspect of the method according to the invention in which an arithmetic unit, by means of operating parameters 34, estimates the cooling performance needed to initiate 36 or stop 38 operation of the separate cooling device 16.

FIG. 4 shows an aircraft comprising an air conditioning system 2 according to an embodiment of the invention. As an example, two separate cooling devices 16 have been permanently installed and are designed to cool ambient airflows 12 which can flow into the aircraft 40, for example by way of cooling air inlets 42 arranged on a region of the wing halves, which region is situated close to the fuselage. In this way, as an example, cooled ambient air is available to two air conditioning packs which based on the temperature spread carried out by means of the cooling device 16 can overall carry out a larger reduction in the temperature.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

### LIST OF REFERENCE CHARACTERS

2 Air conditioning system

4 Air conditioning pack

6 Passenger cabin

8 Outside air

10 Cabin air

12 Heat sink

14 Incoming cabin air

16 Cooling device

17 Arithmetic unit

18 Ambient airflow

20 Input

22 Intermediate cycle

24 Cooling fan

26 Water injection nozzle

28 Consumer/space

30 Valve

32 Valve

34 Estimate operating parameters

36 Initiate operation

38 Stop operation

40 Aircraft

42 Cooling air inlet

1. An air conditioning system for an aircraft, comprising:
at least one air conditioning pack connectable to at least one cooling air inlet of the aircraft for heat dissipation and configured to cool air and to introduce it at a cabin pressure into a passenger cabin of the aircraft, and
at least one cooling deviceequipped to cool the ambient air flowing into the cooling air inlet, wherein the cooling device is operable separately of the air conditioning pack.

2. The air conditioning system of claim 1, wherein the cooling device is configured as a module accommodatable in a module bay of an aircraft.

3. The air conditioning system of claim 1, wherein the cooling device is configured as an air conditioning system integratable permanently in the aircraft.

4. The air conditioning system of claim 3, wherein the cooling device is configured to provide, during the flight of the aircraft, the cooling performance used for the cooling of devices within the aircraft.

5. The air conditioning system of claim 4, wherein the cooling device is connectable to an air outlet and an air inlet of a space in the aircraft and comprises a fan for conveying air from the air outlet of the space to the cooling device and from the cooling device to the air inlet of the space.

6. The air conditioning system of claim 5, further comprising a valve arrangement for selectively connecting the cooling air inlet or the air outlet of a space to the separate cooling device.

7. The air conditioning system of claim 1, wherein the cooling device is configured as a heat exchanger configured for a liquid coolant supplied from outside the aircraft to flow through it.

8. The air conditioning system of claim 1, further comprising an arithmetic unit configured to carry out an estimate of a necessary cooling performance based on operating parameters, to, when a cooling performance that is providable by the air conditioning pack is exceeded, indicate the use of an additional, separately-operable, cooling device, and when said cooling performance is not reached to indicate de-activation of said cooling device.

9. A method for cooling incoming cabin air for a passenger cabin of an aircraft, comprising:
cooling ambient air supplied from the outside with the use of a cooling device; and
cooling air with the use of an air conditioning pack giving off heat to the cooled ambient air.

10. The method of claim 9, further comprising estimating a necessary cooling performance based on operating parameters, to, when a cooling performance providable by the air conditioning pack is exceeded, operate an additional, separately-operable cooling device, for cooling ambient air from a cooling air inlet, and when said cooling performance is not reached to deactivate said cooling device.
